(19) United States
(12) Patent Application Publication
(10) Pub. No.: US 2012/0129499 A1
(43) Pub. Date: May 24, 2012

(54) Method, Apparatus and System for Processing Security Key when Reestablishing Radio Resource Control (RRC) Connection

(75) Inventor: Jinglan Li, Guangdong Province (CN)

(73) Assignee: ZTE CORPORATION, Shenzhen, Guangdong Province (CN)

(21) Appl. No.: 13/382,496

(22) PCT Filed: May 14, 2010
(86) PCT No.: PCT/CN10/72816

§ 371 Date: Jan. 5, 2012

(30) Foreign Application Priority Data
Jul. 9, 2009 (CN) 200910158958.2

(51) Int. Cl. H04W 12/00; H04W 36/00

(52) U.S. Cl. 455/411

(57) ABSTRACT

A method for processing a security key when a Radio Resource Control (RRC) connection is reestablished is provided, which comprises: receiving a Radio Resource Control connection reestablishment request from a user equipment by a node B; the node B judging whether there is a need to generate a new access layer security key, and generating the new access layer security key or using an original access layer security key based on this judgment result; and sending corresponding Radio Resource Control connection reestablishment information to the user equipment by the node B, so that the user equipment carries out the connection reestablishment. The method adds in the judgment steps into the process of generating an access layer security key, and thus solving the problem in the conventional method that a new key is generated regardless of the situation, thereby saving a large number of computation process of generating the key and reducing the time delay of the systems.

### FIELD OF THE INVENTION

The present invention relates to the mobile communication security field, and in particular to a method, an apparatus and a system for processing a security key when reestablishing a Radio Resource Control (RRC) connection.

### BACKGROUND OF THE INVENTION

In the Long Term Evolution (LTE) system, the RRC function of the network is carried out in an eNB (E-UTRAN Node B, Evolved Universal Terrestrial Radio Access Network Node B), and therefore the security protection mechanism corresponding to the RRC also is in the eNB. Because of the large number, wide distribution area and high decentralization (no matter from the geographical position or the logic) of various network entities among the access layer of the eNB deployments, the operators being incapable of carrying out the centralized control of security to them and each eNB being in a non-secure area, every eNB each needs to generate, by itself, a key used for the access layer security mechanism between them and every UE (User Equipment).

According to the description of the 33.401 protocol, during the process of initial context establishment initiated by MME (Mobility Management Entity, which is an entity of the core network), the MME carries an access layer (AS) root key K_{eNB} within the initial context establishment request information to the eNB, and the eNB then generates three keys, AS layer signaling integrity protection key K_{RreInt}, signaling encryption key K_{RrcEnc} and user data encryption key K_{UpEnc}, by using Key Derivation Function (KDF) according to the K_{eNB}.

In general, K_{eNB} does not change. Only when a handover occurs or the RRC connection is reestablished does the eNB need to generate a new AS layer root key K*_{eNB} according to a new NH (Next Hop, which is provided by the core network) value or the current access layer root key K_{eNB} (when there is no the new NH), Target Physical Cell ID (PCI) and Target Physical Cell Downlink Frequency (EARFCN-DL), and then to generate the three keys used for the AS layer integrity protection and encryption by using the KDF according to the K*_{eNB}.

In the conventional art, the process of processing the RRC connection reestablishment is shown as FIG. 1.

When the UE initiates an RRC connection reestablishment request no matter under what circumstance, the eNB, after receiving the RRC connection reestablishment request, needs to generate a new access layer root key K*_{eNB} by invoking the KDF process according to the NH value saved locally or the K_{eNB}, the PCI and the EARFCN-DL which are used currently, then carries a corresponding next hop chaining count (Next Hop Chaining Count, which is provided by the core network and corresponds to the NH and the K_{eNB} one by one, and the value range thereof is 0-7) value to the UE through RRC connection reestablishment information, and the UE determines according to the next hop chaining count value to generate a new access layer root key K*_{eNB} by using the new NH (when the next hop chaining count value is greater than the next hop chaining count value saved locally, the new NH is used) or the K_{eNB} (when the next hop chaining count value is equal to the next hop chaining count value saved locally, the current K_{eNB} is used).

In the LTE, each eNB maintains respectively the access layer security key between the eNB itself and the UE. Therefore when an X2 interface or an S1 interface handover occurs, of course the access layer key also needs to change subsequently due to the change of the eNB. However, in the conventional art, there is such a problem in the method for processing the security key when the RRC connection is reestablished: when the RRC connection reestablishment on the present eNB occurs, under the circumstance that no change occurs in the eNB and in the UE and no security problem occurs (for example: the key is intercepted by an attacker, the examination of integrity protection fails and the shared root key K_{ASME} between the core network and the UE expires, and these circumstances generally do not occur), in fact, there is no need to update the access layer security key shared between the eNB and the UE and it can not affect the security of the access layer. If the key update is all performed once regardless of the situation, the amount of the computation (once key update needs four times of KDF processes respectively) at the eNB side and at the UE side and the time delay of the entire LTE system will be greatly increased.

### SUMMARY OF THE INVENTION

The present invention is proposed aiming at the above problem in the conventional art that the key update is performed regardless of the situation, for this purpose, the main object of the present invention is to provide a method for processing a security key when RRC connection is reestablished, so as to perform the key update aiming at various situations.

In order to achieve the above object, according to an aspect of the present invention, a method for processing a security key when a Radio Resource Control connection is reestablished is provided, which comprises the following steps: receiving a Radio Resource Control connection reestablishment request from a user equipment by a node B; the node B judging whether there is a need to generate a new access layer security key, and generating the new access layer security key or using an original access layer security key based on this judgment result; and sending corresponding Radio Resource Control connection reestablishment information to the user equipment by the node B, so that the user equipment carries out the connection reestablishment.

Preferably, the step of the node B judging whether there is a need to generate a new access layer security key, and generating the new access layer security key or using an original access layer security key based on this judgment result comprises: judging that the node B is a target node B, with the target node B being located in a cell where a handover occurred, and then determining that there is no need to generate a new access layer key; and the node B using an access layer key obtained during the handover as an access layer key for the current reestablishment, and performing a local configuration by using a security configuration existing when the handover occurs.

Preferably, the step of the node B judging whether there is a need to generate a new access layer security key, and generating the new access layer security key or using an original access layer security key based on this judgment result comprises: judging that the node B is a target node B, with the target node B being a node B after an X2 handover and the target node B not being located in the cell where the handover occurred, and then determining to generate a new access layer key; and the target node B selecting a key K*_{eNB} corresponding to a cell where the Radio Resource Control connection is reestablished from a key list which is carried in a handover request message and used for reestablishing the Radio Resource Control connection, and using the selected key as an access layer root key K_{eNB} when the Radio Resource Control connection is reestablished.

Preferably, the step of the node B judging whether there is a need to generate a new access layer security key, and generating the new access layer security key or using an original access layer security key based on this judgment result comprises: judging that the node B is a target node B, with the target node B being a node B after an S1 handover and the target node B not being located in the cell where the handover occurred, and then determining to generate a new access layer key; and the target node B generating the new access layer key according to {NH, NCC} in a handover request message, and using the access layer key as an access layer security key when the RRC connection is reestablished.

Preferably, the step of the node B judging whether there is a need to generate a new access layer security key, and generating the new access layer security key or using an original access layer security key based on this judgment result comprises: judging that the node B is a source node B, with no security problem existing in the source node B and a next hop chaining count value saved locally not being 0, and then determining that there is no need to generate a new access layer key; and the node B performing a local configuration by using a previous security configuration.

Preferably, the step of the node B judging whether there is a need to generate a new access layer security key, and generating the new access layer security key or using an original access layer security key based on this judgment result comprises: judging that the node B is a source node B, with a security problem existing in the source node B or a next hop chaining count value saved locally being 0, and then determining to generate a new access layer key; and the node B invoking a Key Derivation Function (KDF) by using a current K_{eNB} or new NH, PCI and EARFCN-DL, and generating a new access layer root key K*_{eNB}, and then saving a next hop chaining count value corresponding to the K*_{eNB} to the local and saving the K*_{eNB} as the K_{eNB} when the Radio Resource Control connection is reestablished to the local.

Preferably, after the node B sending corresponding Radio Resource Control connection reestablishment information to the user equipment, the method further comprises: receiving the Radio Resource Control connection reestablishment information from the node B by the user equipment; and the user equipment generating corresponding Radio Resource Control connection reestablishment completion information according to the Radio Resource Control connection reestablishment information received from the node B, and sending the Radio Resource Control connection reestablishment completion information to the node B.

Preferably, before the user equipment receiving the Radio Resource Control connection reestablishment information from the node B, the method further comprises: the user equipment judging, according to a comparison result between the next hop chaining count value contained in the received Radio Resource Control connection reestablishment information and the next hop chaining count value locally saved by the user equipment, whether there is a need to correspondingly generate a new access layer security key which is identical to that at the node B side, performing the local configuration, and generating the corresponding Radio Resource Control connection reestablishment completion information.

Preferably, if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

A node B is provided according to another aspect of the present invention, which apparatus comprises: a receiving module configured for the node B to receive a Radio Resource Control connection reestablishment request from a user equipment; a first judging module configured for the node B to judge whether there is a need to generate a new access layer security key, and to generate the new access layer security key or use an original access layer security key based on this judgment result; and a sending module configured for the node B to send corresponding Radio Resource Control connection reestablishment information to the user equipment, so that the user equipment carries out the connection reestablishment.

Preferably, the apparatus further comprises: a second judging module configured for the node B to judge that the node B itself is a source node B or a target node B according to whether a node ID corresponding to a physical cell ID carried in the received Radio Resource Control connection reestablishment request is identical to the ID of the node B.

According to further another aspect of the present invention, a system for processing a security key when a Radio Resource Control connection is reestablished is provided, which comprises: all technical characteristics of the above node B and user equipment.

The present invention adopts a method that different processing is to implement for an access layer security key according to the different situations occurred by the RRC connection reestablishment, and the method adds the judgment step into the process of generating an access layer security key, thus solving the problem in the conventional method that a new key is generated regardless of the situation, thereby saving a large number of computation process of generating the key and reducing the time delay of the systems.

Other characteristics and advantages of the present invention will be explained in the following description, and moreover, partly become obvious from the description, or be understood by implementing the present invention. The objects and other advantages of the present invention can be realized and obtained through the structures specially indicated in the description, claims and drawings.

### BRIEF DESCRIPTION OF THE DRAWINGS

The drawings herein are used to provide a further understanding of the present invention and form a part of the description, which are used to explain the present invention together with the embodiments of the present invention without unduly limiting the scope of the present invention. In the drawings:

FIG. 1 is a flowchart of processing an access layer security key when RRC connection is reestablished in the conventional art;

FIG. 2 is a flowchart of a method for processing an access layer security key when RRC connection is reestablished according to an embodiment of the present invention;

FIG. 3 is a flowchart of a preferred method for processing an access layer security key when RRC connection is reestablished according to an embodiment of the present invention;

FIG. 4 is a specific application flowchart of a method for processing an access layer security key when RRC connection is reestablished according to an embodiment of the present invention;

FIG. 5 is a specific application flowchart of a method for processing an access layer security key when RRC connection is reestablished according to an embodiment of the present invention;

FIG. 6 is a specific application flowchart of a method for processing an access layer security key when RRC connection is reestablished according to an embodiment of the present invention;

FIG. 7 is a structural block diagram of an apparatus for processing an access layer security key when RRC connection located in a node B side is reestablished according to an embodiment of the present invention; and

FIG. 8 is a preferred structural block diagram of an apparatus for processing an access layer security key when RRC connection is reestablished according to an embodiment of the present invention.

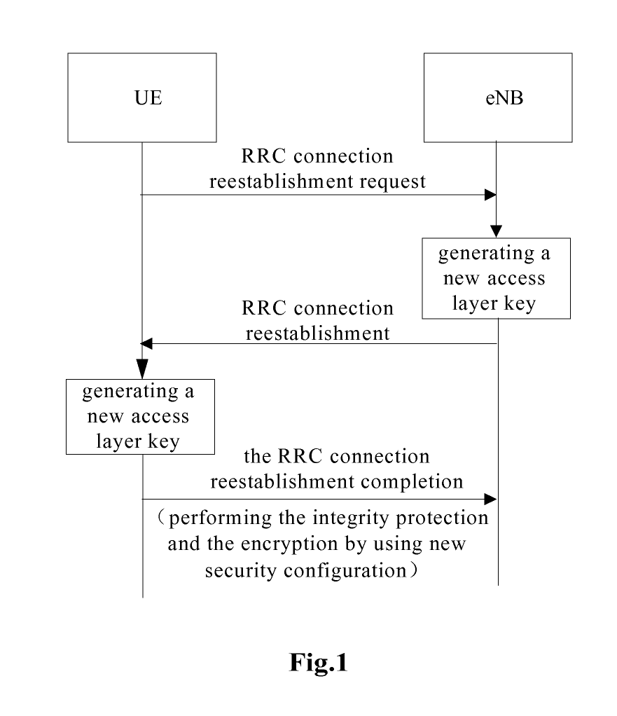

### DETAILED DESCRIPTION OF EMBODIMENTS

A detailed description is given to the preferred embodiments of the invention with reference to the accompanying drawings. The preferred embodiment of the present invention is described for the purpose of illustration, not for limiting the present invention.

Functional Overview

Considering the problem in the conventional LTE that keys are updated regardless of situations, thereby greatly increasing the amount of computation at the eNB side and at the UE side (once of key update needs four times of KDF processes respectively) and the time delay of the entire LTE system, the embodiments of the present invention provide a solution to process security keys when an RRC connection is reestablished. When the RRC connection is reestablished, the eNB side adds a judgment step after receiving an RRC connection reestablishment request from the UE: if the RRC connection reestablishment request is at the source eNB side and caused by a non-security problem, and a next hop chaining count value locally saved by the eNB is not 0, then the access layer key update will not be performed; if the RRC connection reestablishment request is at the target eNB side and in a cell where a handover occurs, then the access layer key generated during the handover is used. According to the method proposed by the present invention for processing the access layer key when the RRC connection is reestablished, the eNB and the UE only need to add a judgment step when the RRC connection reestablishment occurs, which can save a large number of computation process of generating the keys, can significantly reduce the loads of the eNB and the UE, and can be very beneficial especially for the UE with the limited computation capability; moreover, which can reduce the time delay of systems and improve the connection speed of the RRC connection reestablishment.

### Method Embodiments

A method for processing a security key when an RRC connection is reestablished is provided according to an embodiment of the present invention.

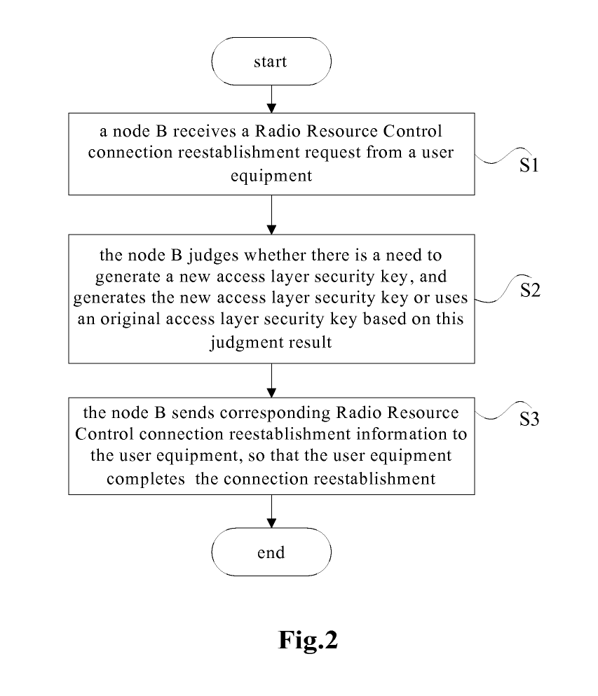

FIG. 2 is a flowchart of a method for processing an access layer security key when RRC connection is reestablished according to an embodiment of the present invention.

As shown in FIG. 2, the method comprises the following Step S1 to Step S3.

Step S1, a node B receives a Radio Resource Control connection reestablishment request from a user equipment;

Step S2, the node B judges whether there is a need to generate a new access layer security key, and generates the new access layer security key or using an original access layer security key based on this judgment result; and

Step S3, the node B sends corresponding Radio Resource Control connection reestablishment information to the user equipment, so that the user equipment completes the connection reestablishment.

The present invention judges, during the establishment of the Radio Resource Control (RRC) connection between the User Equipment (UE) and the node B, whether there is a need to generate the access layer key, and then executes the update of the access layer key, by which whether to perform the key update is distinguished according to different situations. This method saves the system resources and improves the operational efficiency of systems, without affecting the security of the access layer. This method is particularly applied after the node B end has received the RRC connection reestablishment request. If at this moment, the node B end and the user equipment have not changed and there is no security problem, then at this moment the access layer security key will not need to be updated.

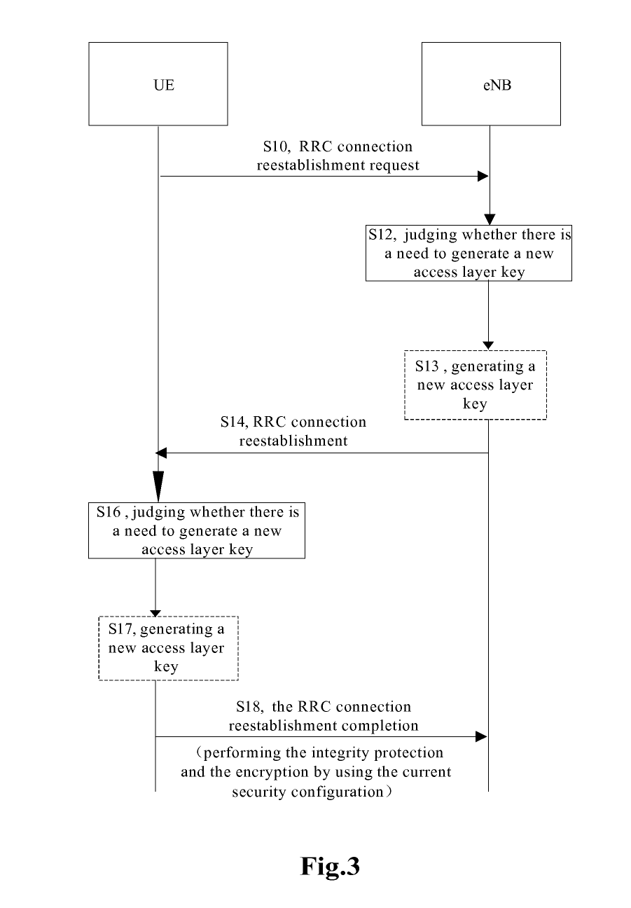

FIG. 3 is a flowchart of a preferred method for processing an access layer security key when RRC connection is reestablished according to an embodiment of the present invention. As shown in FIG. 3, the method comprises the following Step S10 to Step S18.

Step S10, the eNB receives an RRC connection reestablishment request from the UE;

Step S12, the eNB judges whether there is a need to generate a new access layer security key;

Step S14, the eNB sends corresponding RRC connection reestablishment information to the UE;

Step S16, the UE judges, according to the received RRC connection reestablishment information, whether there is a need to generate a new access layer security key which is identical to that of the eNB, then performs local configuration, and further generates corresponding RRC connection reestablishment completion information; and

Step S18, the UE sends the generated RRC connection reestablishment completion information to the eNB.

In above steps, when performing the Step S12, the eNB judges whether the eNB is a source eNB or a target eNB, wherein if the eNB is a source eNB, the reason that the RRC connection reestablishment request occurs is a non-security problem and a next hop chaining count value saved locally is not 0, a new access layer security key will not need to be generated; if the eNB is a target eNB and the eNB is located in the cell where the handover occurred, a new access layer security key will not need to be generated either.

If in the Step S12 it is determined that the eNB is a source eNB and the reason that the RRC connection reestablishment request occurs is a security problem or a next hop chaining count value saved locally is 0, or it is determined that the eNB is a target eNB and the target eNB is not located in the cell where the handover occurred, a new access layer security key will need to be generated, and at this moment the Step S13 will need to be executed.

In above steps, in the Step S16, the UE judges, according to a comparison result between the next hop chaining count value contained in the received RRC connection reestablishment information and the next hop chaining count value locally saved by the UE, whether there is a need to generate a new access layer security key which is identical to that of the eNB side.

If in the Step S16 it is determined that there is a need to generate a new access layer security key which is identical to that of the eNB side, then at this moment the Step S17 will need to be executed, and the UE will generate the new access layer security key which is identical to that of the eNB side according to the information contained in the RRC connection reestablishment information from the eNB side.

In above steps, the Step S13 and the Step S17 are to generate a new access layer key.

It should be noted that under the circumstance that the target eNB is located in the cell where the handover occurred, although the target eNB does not need to generate a new security key, the UE generates a new security key according to the connection reestablishment information (at this moment, the NCC contained in the information is the NCC corresponding to the key generated during the eNB performs the handover).

In the present embodiment, the eNB end judges whether there is a need to generate a new access layer security key, by which whether to generate new security key can be selected according to different implementing circumstances, and therefore, under the circumstance that the key does not need to be updated, the amount of computation in the eNB side and in the user equipment side is greatly reduced and the system resources are saved.

A detailed description with reference to FIGS. 3-5 is given hereinafter to the specific application of a method for processing an access layer security key when RRC connection is reestablished according to an embodiment of the present invention.

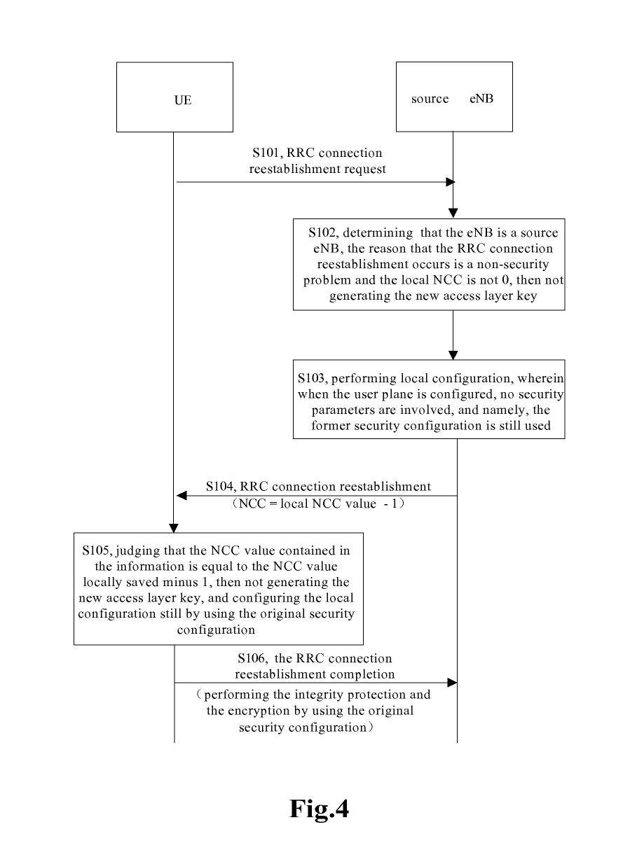

FIG. 4 is a specific application flowchart of a method for processing an access layer security key when RRC connection is reestablished according to an embodiment of the present invention. In the present embodiment, the UE sends an RRC connection reestablishment request to a source eNB connected previously by the UE, a next hop chaining count value locally saved is not 0, and the reason that the RRC connection reestablishment occurs is a non-security problem, then the access layer security key will not need to be updated in this condition, specific process of which is shown as FIG. 4. The process comprises the following steps.

Step 101, the UE sends RRC connection reestablishment request information to the eNB;

Step 102, after receiving the RRC connection reestablishment request information, the eNB determines, according to the physical cell ID contained in the information, that the eNB is a source eNB connected by the UE before the UE sent the RRC connection reestablishment information (at this moment, the ID of the current eNB is consistent with the node ID corresponding to the physical cell ID carried in the RRC connection reestablishment request), determines that the reason, contained in the information, that the RRC connection reestablishment occurs is a non-security problem, and determines that the next hop chaining count value locally saved by the eNB is not 0. Then the new access layer security key will not need to be generated;

Step 103, the eNB performs local configuration, wherein when the user plane of the eNB is configured, no security parameters are involved, and namely, the former security configuration is still used;

Step 104, the eNB creates RRC connection reestablishment information, wherein the next hop chaining count value locally saved minus 1 is assigned to the next hop chaining count value in the RRC connection reestablishment information, and then sends this information to the UE;

Step 105, the UE, after receiving the RRC connection reestablishment information, compares the next hop chaining count value contained in the information with the next hop chaining count value locally saved by it. And if the next hop chaining count value contained in the information is equal to the next hop chaining count value locally saved minus 1, which means that the security parameters have not changed, and at this moment, the UE performs the local configuration according to the RRC connection reestablishment information without changing the security configuration; and

Step 106, the UE creates the RRC connection reestablishment completion information, and sends it to the eNB after it has been performed the integrity protection and encryption by using the original security configuration; the eNB receives the RRC connection reestablishment completion information from the UE, and then the process of the RRC connection reestablishment ends.

The present embodiment, under the circumstance that the eNB side is the source node B, after the eNB receives the RRC connection reestablishment request, judges that no security problem exists in the node B and the local NCC is not 0, at this moment the key will not need to be updated and the former security configuration can be used, thereby greatly reducing the amount of computation at the source eNB side and at the user equipment side and saving the system resources. It can distinguish different implementing circumstances to select whether to generate the new security key.

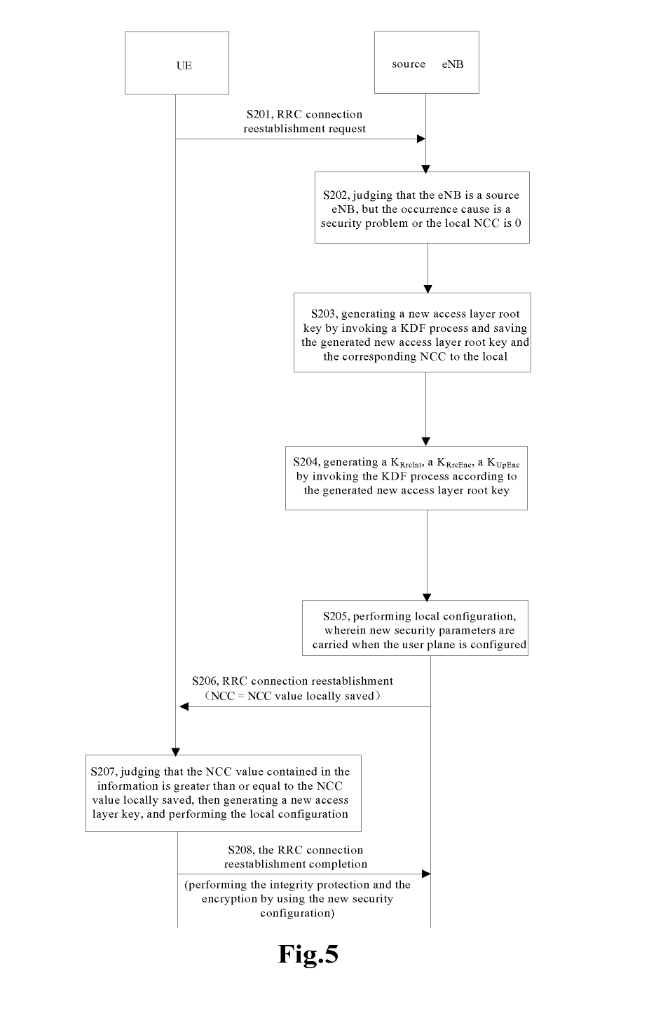

FIG. 5 is a specific application flowchart of a method for processing an access layer security key when RRC connection is reestablished according to an embodiment of the present invention. In the present embodiment, firstly it also needs to be determined that the UE has sent an RRC connection reestablishment request to a source eNB connected previously by the UE, but the reason that the RRC connection reestablishment occurs contained in the information is a security problem or a next hop chaining count value locally saved by the eNB is 0; then there is a need to update the access layer security key at this moment. The particular steps are shown as FIG. 5 and comprise the following steps.

Step 201, the UE sends the RRC connection reestablishment request information to the eNB;

Step 202, the eNB, after receiving the RRC connection reestablishment request information, judges, according to the physical cell ID contained in the RRC connection reestablishment information, that the eNB is a source eNB which is connected before sending the RRC connection reestablishment information, but wherein the reason that the RRC connection reestablishment occurs contained in the information is a security problem or a next hop chaining count value locally saved by the eNB is 0;

Step 203, the eNB generates a new access layer root key K*_{eNB} by invoking a KDF process, saves the next hop chaining count value corresponding to the K*_{eNB} to the local, and then saves the K*_{eNB} to the local as an access layer root key K_{eNB} of reestablishing the RRC connection;

Step 204, the eNB invokes the KDF according to the K_{eNB}, and then generates a K_{RreInt}, a K_{RrcEnc} and a K_{UpEnc};

Step 205, the eNB performs local configuration, wherein new security parameters are carried when the eNB user plane is configured;

Step 206, the eNB creates RRC connection reestablishment information, wherein the next hop chaining count value locally saved is assigned to the next hop chaining count value contained in the RRC connection reestablishment information, and then the information is sent to the UE;

Step 207, the UE, after receiving the RRC connection reestablishment information, compares the next hop chaining count value contained in the information with the next hop chaining count value locally saved by it, and if the next hop chaining count value contained in the information is greater than or equal to the next hop chaining count value locally saved, which indicates that the security parameters have changed, at this moment, the UE will generate a new access layer key according to a new NH value or the current K_{eNB}, and the UE performs the local configuration according to the RRC connection reestablishment information and the newly generated security parameters; and

Step 208, the UE creates the RRC connection reestablishment completion information and sends it to the eNB after it has been performed the integrity protection and encryption by using the new security configuration; the eNB receives the RRC connection reestablishment completion information from the UE, and then the process of the RRC connection reestablishment ends.

The present embodiment, under the circumstance that the eNB side is the source node B, after the eNB receives the RRC connection reestablishment request, judges that the security problem exists in the node B and the local NCC is 0, therefore the key needs to be updated and the KDF process is invoked according to the generated new access layer key, and the security configuration parameters are carried when the user plane is configured. The method distinguishes different implementing circumstances to select whether to generate the new security key.

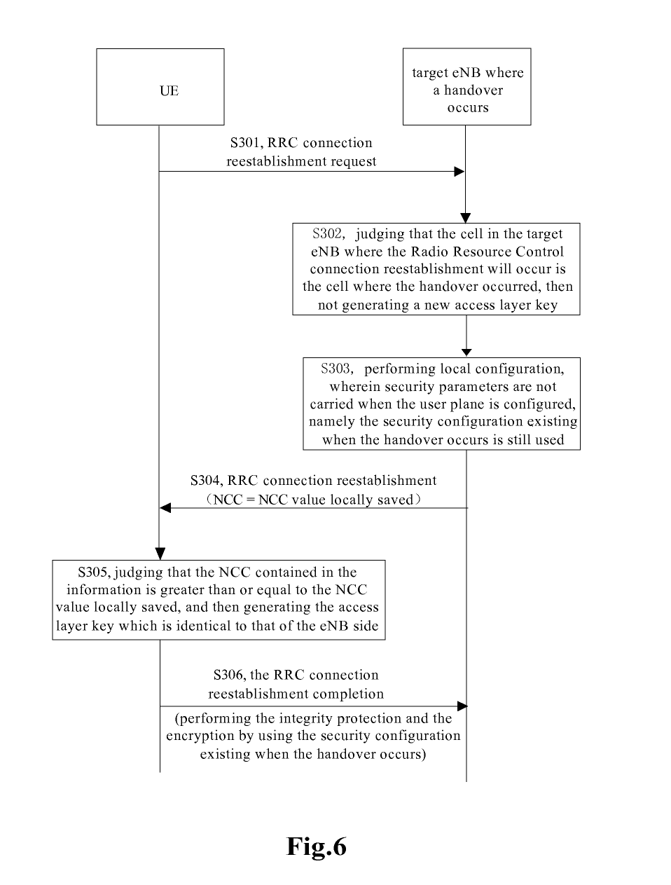

FIG. 6 is a specific application flowchart of a method for processing an access layer security key when RRC connection is reestablished according to an embodiment of the present invention. In the present embodiment, an X2 or S1 handover occurs in the eNB, and the target eNB receives the RRC connection reestablishment request from the UE side, wherein it should be noted that the reason that the UE sends the connection reestablishment request to the eNB is that the target eNB sends reconfiguration information to the UE side through the source eNB when performing the handover, which make the UE side perform reconfiguration for itself according to the new configuration existing after the handover occurs, so as to generate a set of local configuration which is identical to that of the target eNB side. However, if the reconfiguration fails, it may be possible for the UE to send the connection reestablishment request to the target eNB.

When the system determines that the current cell in the eNB is a cell where the handover occurred, the access layer security key of reestablishing the RRC connection uses the key generated during the handover. The particular process is shown as FIG. 6 and comprises the following steps.

Step 301, the UE sends the RRC connection reestablishment request information to the eNB;

Step 302, the eNB, after receiving the RRC connection reestablishment information, judges that itself is a target eNB and is located in the cell where the handover occurred according to the physical cell ID contained in the RRC connection reestablishment information;

Step 303, the eNB performs local configuration, wherein security parameters are not carried when the eNB user plane is configured, namely the security configuration existing when the handover occurs is still used;

Step 304, the eNB creates RRC connection reestablishment information, wherein the next hop chaining count value locally saved is assigned to the next hop chaining count value in the RRC connection reestablishment information, and then sends the RRC connection reestablishment information to the UE;

Step 305, the UE, after receiving the RRC connection reestablishment information, compares the next hop chaining count value contained in the RRC connection reestablishment information with the next hop chaining count value locally saved by it. And if the next hop chaining count value contained in the RRC connection reestablishment information is greater than or equal to the next hop chaining count value locally saved (because the reconfiguration information sent to the UE during the handover does not work), the UE will generate a access layer key which is identical to that of the eNB side according to a new NH value or the current K_{eNB}, and thereby the UE performs the local configuration according to the RRC connection reestablishment information and the generated security parameters; and

Step 306, the UE creates the RRC connection reestablishment completion information and sends it to the eNB after it has been performed the integrity protection and encryption by using the new security configuration; the eNB receives the RRC connection reestablishment completion information from the UE, and then the process of the RRC connection reestablishment ends.

The present embodiment, under the circumstance that the eNB side is the target node B, after the eNB receives the RRC connection reestablishment request, judges whether the node B is located in the cell where the handover occurred, wherein under the circumstance that the node B is located in the cell where the handover occurred, the key does not need to be updated, and when the user plane is configured, no new security configuration parameters need to be carried and the original security configuration is used. The method distinguishes different implementing circumstances to select whether to generate the new security key.

It should be noted that if the eNB judges according to the physical cell ID carried within the received RRC connection reestablishment information that itself is a target eNB where the handover occurs but is not located in the cell where the handover occurred, then the new access layer security key needs to be generated at this moment. In this case, in the embodiment of the present invention, if the X2 handover occurs in the eNB, the node B will select a key K*_{eNB} corresponding to a cell where the RRC connection is reestablished from a key list which is carried in a handover request message and used for reestablishing the Radio Resource Control (RRC) connection, use the selected key as an access layer root key K_{eNB} when the Radio Resource Control connection is reestablished, and save the access layer root key together with the Next Hop Chaining Count (NCC) value corresponding thereto to the local; but if the S1 handover occurs in the eNB, the new access layer key will be generated as the access layer security key of reestablishing the RRC connection by using the {NH, NCC} pair within the handover request according to the method for generating the key. Thereby, the eNB invokes the KDF according to the K_{eNB} and generates the K_{RreInt}, K_{RrcEnc} and K_{UpEnc}, and then the eNB creates the RRC connection reestablishment information, wherein the NCC value locally saved is assigned to the NCC value contained within the RRC connection reestablishment information, and sends the information to the UE. The follow-up steps are identical to the above Steps 207-208.

### Apparatus Embodiment

According to an embodiment of the present invention, a node B is further provided.

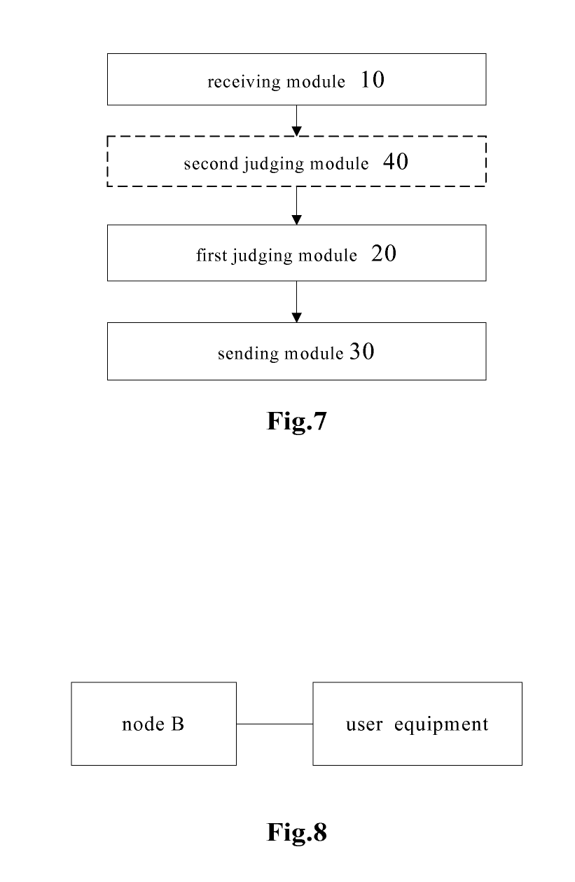

FIG. 7 is a structural block diagram of the apparatus. As shown in FIG. 7, the apparatus comprises: a receiving module 10, a first judging module 20 and a sending module 30.

In the apparatus, the receiving module 10 is configured for the node B to receive a Radio Resource Control connection reestablishment request from user equipment (which is configured to execute the function of the Step S10);

the first judging module 20 is configured for the node B to judge whether there is a need to generate a new access layer security key, and to generate the new access layer security key or to use an original access layer security key based on this judgment result (which is configured to execute the function of the Step S12 and the Step S13); and

the sending module 30 is configured for the node B to send corresponding Radio Resource Control connection reestablishment information to the user equipment, so that the user equipment carries out the connection reestablishment (which is configured to execute the function of the Step S14).

Preferably, the apparatus further comprises: a second judging module 40, configured for the node B to judge that the node B itself is a source node or is a target node according to whether a node ID corresponding to a physical cell ID carried in the received Radio Resource Control connection reestablishment request is identical to the ID of the node B.

In above apparatus, the first judging module 20 judges, according to the RRC connection reestablishment request received by the receiving module 10, whether the eNB is a source eNB or a target eNB, wherein if the eNB is a source eNB, the reason that the RRC connection reestablishment request occurs is a non-security problem and a next hop chaining count value saved locally is not 0, a new access layer security key will not need to be generated; if the eNB is a target eNB and the eNB is located in the cell where the handover occurred, a new access layer security key will not need to be generated neither.

If the first judging module 20 determines that the reason that the RRC connection reestablishment request occurs is a security problem or a next hop chaining count value saved locally is 0, or the target eNB is not located in the cell where the handover occurred, a new access layer security key will need to be generated at this time.

According to the embodiment of the present invention, a system for processing a security key when RRC connection is reestablished is provided. FIG. 8 illustrates a structural block diagram of the system. As shown in FIG. 8, the system comprises: all technical characteristics about the above node B and the user equipment.

Above description is only to illustrate the preferred embodiments but not to limit the present invention. Various alterations and changes to the present invention are apparent to those skilled in the art. The scope defined in claims shall cover any modification, equivalent substitution and improvement within the spirit and principle of the present invention.

1. A method for processing a security key when a Radio Resource Control connection is reestablished, comprising the following steps of:
receiving a Radio Resource Control connection reestablishment request from a user equipment by a node B;
the node B judging whether there is a need to generate a new access layer security key, and generating the new access layer security key or using an original access layer security key based on this judgment result; and
sending corresponding Radio Resource Control connection reestablishment information to the user equipment by the node B, so that the user equipment carries out the connection reestablishment.

2. The method for processing the security key when the Radio Resource Control connection is reestablished according to claim 1, wherein the step of the node B judging whether there is a need to generate a new access layer security key, and generating the new access layer security key or using an original access layer security key based on this judgment result comprises:
judging that the node B is a target node B, with a cell in the target node B where the Radio Resource Control connection reestablishment will occur being a cell where a handover occurred, and then determining that there is no need to generate a new access layer key; and
the node B using an access layer key obtained during the handover as an access layer key for the current reestablishment, and performing a local configuration by using a security configuration existing when the handover occurs.

3. The method for processing the security key when the Radio Resource Control connection is reestablished according to claim 1, wherein the step of the node B judging whether there is a need to generate a new access layer security key, and generating the new access layer security key or using an original access layer security key based on this judgment result comprises:
judging that the node B is a target node B, with the target node B being a node B after an X2 handover and the cell in the target node B where the Radio Resource Control connection reestablishment will occur not being the cell where the handover occurred, and then determining to generate a new access layer key; and
the target node B selecting a key K*_{eNB} corresponding to a cell where the Radio Resource Control connection is reestablished from a key list which is carried in a handover request message and used for reestablishing the Radio Resource Control connection, and using the selected key as an access layer root key K_{eNB} when the Radio Resource Control connection is reestablished.

4. The method for processing the security key when the Radio Resource Control connection is reestablished according to claim 1, wherein the step of the node B judging whether there is a need to generate a new access layer security key, and generating the new access layer security key or using an original access layer security key based on this judgment result comprises:
judging that the node B is a target node B, with the target node B being a node B after an S1 handover and the cell in the target node B where the Radio Resource Control connection reestablishment will occur not being the cell where the handover occurred, and then determining to generate a new access layer key; and
the target node B generating the new access layer key according to {Next Hop (NH), Next Hop Chaining Count (NCC)} in a handover request message, and using the access layer key as an access layer security key when the Radio Resource Control (RRC) connection is reestablished.

5. The method for processing the security key when the Radio Resource Control connection is reestablished according to claim 1, wherein the step of the node B judging whether there is a need to generate a new access layer security key, and generating the new access layer security key or using an original access layer security key based on this judgment result comprises:
judging that the node B is a source node B, with no security problem existing in the source node B and a next hop chaining count value saved locally not being 0, and then determining that there is no need to generate a new access layer key; and
the node B performing local configuration by using a previous security configuration.

6. The method for processing the security key when the Radio Resource Control connection is reestablished according to claim 1, wherein the step of the node B judging whether there is a need to generate a new access layer security key, and generating the new access layer security key or using an original access layer security key based on this judgment result comprises:
judging that the node B is a source node B, with a security problem existing in the source node B or a next hop chaining count value saved locally being 0, and then determining to generate a new access layer key; and
the node B invoking a Key Derivation Function (KDF) by using a current K_{eNB} or new Next Hop (NH), Target Physical Cell ID (PCI) and Target Physical Cell Downlink Frequency (EARFCN-DL), and generating a new access layer root key K*_{eNB}, and then saving a next hop chaining count value corresponding to the K*_{eNB} to the local and saving the K*_{eNB} as the K_{eNB} when the Radio Resource Control connection is reestablished to the local.

7. The method for processing the security key when the Radio Resource Control connection is reestablished according to claim 1,
wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completion information according to the Radio Resource Control connection reestablishment information received from the node B, and sending the Radio Resource Control connection reestablishment completion information to the node B.

8. The method for processing the security key when the Radio Resource Control connection is reestablished according to claim 7, wherein before the user equipment receiving the Radio Resource Control connection reestablishment information from the node B, the method further comprises:
the user equipment judging, according to a comparison result between the next hop chaining count value contained in the received Radio Resource Control connection reestablishment information and the next hop chaining count value locally saved by the user equipment, whether there is a need to correspondingly generate a new access layer security key which is identical to that at the node B side, performing the local configuration, and generating the corresponding Radio Resource Control connection reestablishment completion information.

9. The method for processing a security key when the Radio Resource Control connection is reestablished according to claim 2,
wherein the method further comprises:
if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and
if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

10. An apparatus for processing a security key when a Radio Resource Control connection is reestablished, comprising:
a receiving module configured for a node B to receive a Radio Resource Control connection reestablishment request from a user equipment;
a first judging module configured for the node B to judge whether there is a need to generate a new access layer security key, and to generate the new access layer security key or use an original access layer security key based on this judgment result; and
a sending module configured for the node B to send corresponding Radio Resource Control connection reestablishment information to the user equipment, so that the user equipment carries out the connection reestablishment.

11. The apparatus for processing a security key when the Radio Resource Control connection is reestablished according to claim 10, wherein the apparatus further comprises:
a second judging module configured for the node B to judge that the node B itself is a source node B or a target node B according to whether a node ID corresponding to a physical cell ID carried in the received Radio Resource Control connection reestablishment request is identical to the ID of the node B.

12. A system for processing a security key when a Radio Resource Control connection is reestablished, comprising the apparatus as claimed in claim 10 and a user equipment.

13. The method for processing the security key when the Radio Resource Control connection is reestablished according to claim 2, wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completed information according to the Radio Resource Control connection reestablishment information received from the node B, and sending the Radio Resource Control connection reestablishment completion information to the node B.

14. The method for processing the security key when the Radio Resource Control connection is reestablished according to claim 3, wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completed information according to the Radio Resource Control connection reestablishment information received from the node B, and sending the Radio Resource Control connection reestablishment completion information to the node B.

15. The method for processing the security key when the Radio Resource Control connection is reestablished according to claim 4, wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completed information according to the Radio Resource Control connection reestablishment information received from the node B, and sending the Radio Resource Control connection reestablishment completion information to the node B.

16. The method for processing the security key when the Radio Resource Control connection is reestablished according to claim 5, wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completed information according to the Radio Resource Control connection reestablishment information received from the node B, and sending the Radio Resource Control connection reestablishment completion information to the node B.

17. The method for processing the security key when the Radio Resource Control connection is reestablished according to claim 6, wherein after the node B sending corresponding Radio Resource Control connection reestablishment information to the user equipment, the method further comprises:
receiving the Radio Resource Control connection reestablishment information from the node B by the user equipment; and
the user equipment generating corresponding Radio Resource Control connection reestablishment completed information according to the Radio Resource Control connection reestablishment information received from the node B, and sending the Radio Resource Control connection reestablishment completion information to the node B.

18. The method for processing a security key when the Radio Resource Control connection is reestablished according to claim 3, wherein the method further comprises:
if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and
if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

19. The method for processing a security key when the Radio Resource Control connection is reestablished according to claim 4, wherein the method further comprises:
if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and
if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

20. The method for processing a security key when the Radio Resource Control connection is reestablished according to claim 5, wherein the method further comprises:
if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and
if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

21. The method for processing a security key when the Radio Resource Control connection is reestablished according to claim 6, wherein the method further comprises:
if a node ID corresponding to a physical cell ID carried in the Radio Resource Control connection reestablishment request is identical to the ID of the node B, the node B being a source node B, wherein the source node B is the node B connected with the user equipment before the user equipment sends the Radio Resource Control connection reestablishment request; and
if the node ID corresponding to the physical cell ID carried in the Radio Resource Control connection reestablishment request is not identical to the ID of the node B, the node B being a target node B, wherein the target node B is the node B which has completed the X2 handover or S1 handover after receiving the Radio Resource Control connection reestablishment request information.

22. A system for processing a security key when a Radio Resource Control connection is reestablished, comprising the apparatus as claimed in claim 11 and a user equipment.
